(19) United States
(12) Patent Application Publication
(10) Pub. No.: US 2014/0073750 A1
(43) Pub. Date: Mar. 13, 2014

(54) CONTROLLED MORPHOLOGY HIGH ACTIVITY POLYOLEFIN CATALYST SYSTEM

(71) Applicant: RELIANCE INDUSTRIES LIMITED, Mumbai (IN)

(72) Inventors: Saurabh SINGH, Surat (IN); Virendrakumar GUPTA, Navi Mumbai (IN); Kamlesh J. SINGALA, Surat (IN); Vallabhbhai S. PATEL, Surat (IN)

(73) Assignee: RELIANCE INDUSTRIES LIMITED, Mumbai (IN)

(21) Appl. No.: 14/080,035

(22) Filed: Nov. 14, 2013

Related U.S. Application Data
(63) Continuation of application No. PCT/IN2012/000350, filed on May 15, 2012.

(30) Foreign Application Priority Data
May 17, 2011 (IN) 762/MUM/2011

(51) Int. Cl. C08F 4/76

(52) U.S. Cl. CPC C08F 4/76
USPC 526/125.3; 502/8; 502/118; 502/125

(57) ABSTRACT

A high activity polyolefin catalyst system comprising titanium containing pro-catalyst component, a co-catalyst component and an external electron donor compound is provided wherein the high activity polyolefin catalyst system is having controlled morphology and less fines. At least one embodiment of the present invention is more directed to provide a method for the preparation of titanium containing pro-catalyst component from solid spherical shaped magnesium containing pro-catalyst precursor wherein the spherical morphology of the pro-catalyst precursor is maintained through out the reaction in order to achieve titanium-containing pro-catalyst having controlled morphology. The polymerization of lower olefins in the presence of high activity polyolefin catalyst having controlled morphology provides polyolefins with minimal polymer fines.

### CROSS REFERENCE TO RELATED APPLICATIONS

This application is a continuation application of international application PCT/IN2012/000350 filed on 15 May 2012 and claims priority under 35 U.S.C 120. The international application PCT/IN2012/000350 claims priority under 35 USC 119 from Indian application 762/MUM/2011 filed on 17 May 2011 wherein the disclosures of the international application and the Indian application are hereby incorporated herein by reference in their entirety.

### FIELD

At least one embodiment of the present invention relates to a high activity polyolefin catalyst composition and method for producing the same. More particularly, at least one embodiment of the present invention relates to a pro-catalyst composition for producing high activity polyolefin catalysts and a method for producing the same. At least one embodiment of the present invention also relates to a polyolefin resin produced by using high activity polyolefin catalyst.

### BACKGROUND

Good flow-ability is a desirable quality of the polymer resins since it is linked with operational benefits such as, higher plant operation rate, less breakdown, less choking problems, and smooth plant operation during both gas and liquid phase polymerization. The flow-ability of the polymer resins is improved by the formation of polymer resins having regular shaped particles and narrow-particle size distribution with low polymer-fines. The polymer resins having regular shaped particles and low polymer-fines show good flow-ability. The morphology of the polymer resins is strongly regulated by the morphology of the catalyst particles being used for the polymerization. The use of ill-defined shaped catalyst particles generally produce polymer resins with relatively broad particle size distribution that contain relatively higher contents of polymer-fines. Synthesis of uniform catalyst particles is generally achieved by using regular-shaped catalyst precursor.

### EXISTING KNOWLEDGE

The conventional Ziegler-Natta type polymerization catalyst comprises active catalyst component derived from at least one transition metal compound selected from the Group IV B, VB or VI B of the Periodic Classification of the Elements and a co-catalyst comprising at least one organo-metallic compound of a metal selected from the group IIA and IIIA of the same classification. The modern conventional Ziegler-Natta type polymerization catalysts also contain a solid inert support.

In the polymerization prior-art, numbers of Ziegler-Natta Polyolefin solid catalysts are known, the composition of which typically comprises a solid pro-catalyst component that contain at least one transition metal compound, typically selected from the compounds of titanium or vanadium, and a magnesium compound such as magnesium chloride in combination with an internal electron donor species, and a co-catalyst component typically chosen from the group of organo-aluminum compounds capable of converting the pro-catalyst into an active polymerization catalyst.

Different types of magnesium containing precursors used for making supported Titanium pro-catalyst for olefin polymerization have been reported in the prior-art. The basic process for making polyolefin pro-catalyst involves treating the magnesium containing precursor with titanium halides, typically the titanium tetrachloride and electron donating species optionally in the presence of a solvent under specified conditions of temperature and mixing conditions.

Various methods of preparing magnesium and titanium containing pro-catalyst precursors for olefin polymerization catalysts have been reported in U.S. Pat. Nos. 5,066,737, 5,106,806, 5,124,298, 5,141,910, 5,229,342. The preferred method of forming the pro-catalyst precursor includes the reaction of alkoxides of magnesium and titanium, with phenolic compounds in the presence of alkanols to form the solid pro-catalyst precursor. The prepared pro-catalyst precursor is then treated with titanium tetrahalide in the presence of halohydrocarbons, preferably chlorobenzene and internal electron donor compounds such as esters, ethers, imines, amides, nitriles etc. to form the pro-catalyst.

The technology disclosed in U.S. Pat. Nos. 6,437,061, 6,395,670 and 6,686,307 comprises the formation of spheroidal magnesium dichloride/alcohol adducts and their subsequent use for the preparation of pro-catalyst components for the polymerization of olefins by reacting the adducts with titanium compounds in the presence of at least two internal donor compounds. The adduct is first suspended in Titanium tetrachloride at 0° C. temperature and heated up to 80° C. to 130° C.

The PCT application WO2004085495 and U.S. Pat. No. 7,482,413 also disclose the formation of substantially spherical particles of solid olefin catalyst by reacting spherical particles of magnesium dichloride/alcohol adduct with excess of Titanium tetrachloride. Electron donor compounds (internal donor) can also be used optionally. All the forgoing patents or patent applications disclose the charging of pro-catalyst precursors at 0° C. or below to prevent sudden reaction and breakage of spherical precursor particles.

Particle breakage can also be prevented by addition of a third component during pro-catalyst precursor synthesis such as ester incorporation, as disclosed in JAPS, Vol. 99, 945-948 (2006), or incorporating small amount of elements selected from the lanthanide or actinide groups, as disclosed in U.S. Pat. No. 7,307,035.

In all the above processes either third component is added in the precursor or the precursor is charged after extended cooling of Titanium tetrachloride, which results in more time and energy consumption.

The activity/performance of a catalyst used for producing polyolefin resins of certain high grade qualities depends up on the morphology of the catalyst particles. The main approach for making regular shaped catalyst particles is to use regular shaped precursors in the catalyst synthesis process and to retain the morphology of the precursor through out the pro-catalyst synthesis process.

From the foregoing discussion of the prior-art it is evident that the morphology of the catalysts plays a role in catalyst performance. In polymerization chemistry there exists a need for continuously adding certain better features in polyolefin resin and therefore, even with available polyolefin catalyst system in prior-art, there is felt a need for another polyolefin catalyst system having improved performance.

### OBJECTS

It is an object of at least one embodiment of the present invention is to provide a controlled morphology polyolefin catalyst composition for the polymerization of olefins.

Another object of at least one embodiment of the present invention is to provide a process for the synthesis of a spherical pro-catalyst.

A further object of at least one embodiment of the present invention is to provide a process for the synthesis of a spherical pro-catalyst wherein the morphology of the pro-catalyst precursor is retained through out the process.

Still further object of at least one embodiment of the present invention is to provide cost effective process for the synthesis of pro-catalyst.

Still further of at least one embodiment of the present invention is to provide a polyolefin resin having better flow-ability and low polymer-fines.

### SUMMARY

In accordance with at least one embodiment of the present invention, there is provided a process for the preparation of titanium pro-catalyst for a controlled morphology high activity polyolefin catalyst system, said process comprising the following steps:
(a) preparing a slurry of tetravalent titanium compound in a solvent system, comprising a mixture of polar and non-polar solvents;
(b) heating the slurry to a temperature in the range of 20° C. to 40° C.;
(c) charging spherical magnesium chloride/alcohol adduct to the heated slurry to obtain a titanium magnesium suspension;
(d) adding an ester to the titanium magnesium suspension to obtain a reaction mixture;
(e) agitating the reaction mixture at a temperature in the range of 60° C. to 135° C. for a period of 5 to 90 minutes to obtain a titanium pro-catalyst having spherical morphology;
(f) optionally purifying the titanium pro-catalyst by treating the obtained titanium pro-catalyst with heated slurry comprising tetravalent titanium compound mixed in a specific combination of polar and non-polar solvent at a reaction temperature of 20° C. to 40° C., followed by agitating the reaction mixture at a temperature in the range of 60° C. to 135° C. for a period of 5 to 90 minutes and adding acid halide compound to the treated titanium pro-catalyst.

Typically, the tetravalent titanium compound is titanium tetrachloride.

Typically, the magnesium chloride-alcohol adduct is selected from the group consisting of magnesium chloride-methanol, magnesium chloride-ethanol, magnesium chloride-isopropanol, magnesium chloride-propanol, magnesium chloride-butanol, magnesium chloride-isobutanol, magnesium chloride-pentanol, magnesium chloride-isopentanol and magnesium chloride-2-ethyl hexanol adduct.

Typically, the solvent system is a mixture of aromatic halohydrocarbon and aliphatic hydrocarbon.

Preferably, the aromatic halohydrocarbon is selected from the group consisting of chlorobenzene, bromobenzene and trichlorobenzene.

Preferably, the aliphatic hydrocarbon is selected from the group consisting of heptane, nonane and decane.

Typically, the ester compound is selected from the group consisting of ethyl benzoate, methyl benzoate, diisobutyl phthalate, diethyl phthalate, dimethyl phthalate, dioctyl phthalate, diisooctyl phthalate.

Typically, the ester can be added from outside or optionally can be generated insitu by adding the corresponding acid halide.

Typically, the acid halide is selected from the group consisting of benzoyl chloride, phthaloyl chloride, and other aliphatic or aromatic acid halides.

Typically, the amount of titanium compound is in the range of 30 to 80% of the mass of total slurry.

Typically, the amount of ester is in the range of 0.5 to 5.0% of the mass of the titanium compound.

Typically, the polar solvent is 1-20% (v/v) of the total mixture of polar and non-polar solvent.

Typically, the titanium pro-catalyst has a particle size in the range of 15-80 micron and particle size distribution span is 0.8-1.4.

In accordance with at least one embodiment of the present invention, there is provided a controlled morphology high activity polyolefin catalyst system comprising:
a. titanium pro-catalyst;
b. triethyl aluminum co-catalyst; and
c. at least one external electron donor.

Typically, the external electron donor is selected from the group consisting of esters of monocarboxylic acids and their substituents, alkoxy alkyl benzoates, alkoxy silanes and dialkoxy silanes.

Preferably, the external electron donor is dicyclohexyl dimethoxy silane.

In accordance with at least one embodiment of the present invention, there is provided a process for the polymerization of α-olefins having from 1 to 10 carbon atoms in the presence of high activity polyolefin catalyst having controlled morphology, comprising the following steps:
a) an activation step wherein the titanium pro-catalyst having controlled morphology is combined with a co-catalyst component to form an activated polyolefin catalyst;
b) introducing an external electron donor compound in the activated polyolefin catalyst to form a high activity polyolefin catalyst system;
c) subjecting an α-olefin monomers to the high activity polyolefin catalyst system under the polymerization condition of temperature in the range of 20° C. to 80° C. and of pressure in the range of 1 kg/cm² to 40 kg/cm² in a polymerization reactor to obtain polyolefins having controlled morphology and less polymer fines.
Typically, the monomers of α-olefins are the monomers of ethylene or propylene.

Typically, the co-catalyst and the titanium pro-catalyst component are present in the molar ratio from 20:1 to 300:1.

Typically, the co-catalyst and the external electron donor component are present in the molar ratio from 20:1 to 50:1.

Typically, the polymerization of lower α-olefins is any one of the phases selected from the group consisting of slurry phase, gas phase and bulk phase polymerization.

Typically, the polymerization of lower α-olefins is carried out in an inert diluent medium selected from the group consisting of hexane, heptanes, decane and cyclohexane.

Typically, the polyolefins of α-olefins having controlled morphology and less polymer fines have average particle size in the range of 0.035 to 0.15 inch.

Typically, the polyolefins of α-olefins having controlled morphology and less polymer fines, wherein the polymer fines have average particle size below 125 μm are present in the range of 1.0% to 1.4%.

### BRIEF DESCRIPTION OF THE ACCOMPANYING DRAWINGS

FIG. 1 represents the Scanning Electron Micrograph Study of the catalyst synthesized by using high polarity solvent at higher charging temperature; the image indicate high fines with irregular shape of the particles.

FIG. 2 represents the Scanning Electron Micrograph Study of the catalyst synthesized by using high polarity solvent at lower charging temperature; the image indicate high fines with irregular shape of particles.

FIG. 3 represents the Scanning Electron Micrograph Study of the catalyst synthesized by using low polarity solvent at higher charging temperature; the image indicate lower fines with improved morphology.

FIG. 4 represents the Scanning Electron Micrograph Study of the catalyst synthesized by using low polarity solvent at lower charging temperature; the image indicate lower fines with improved morphology.

FIG. 5 represents the Scanning Electron Micrograph Study of the catalyst synthesized without using solvent at higher charging temperature; and the image indicate very low fines with good morphology retention.

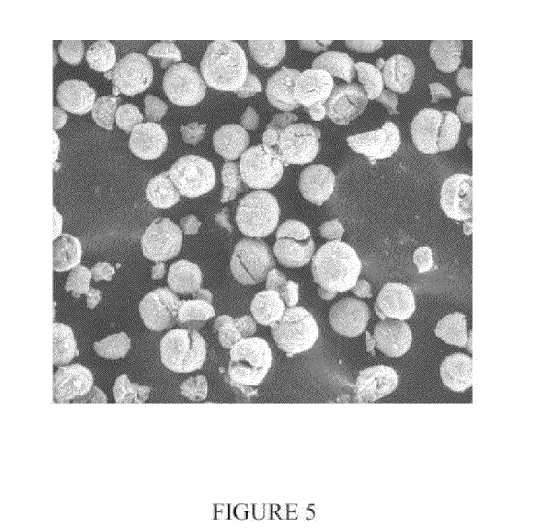

FIG. 6 represents the Scanning Electron Micrograph Study of the catalyst synthesized with using mixture of polar and non-polar solvent at higher charging temperature; and the image indicate very low fines with good morphology retention.

FIG. 7 represents the Scanning Electron Micrograph Study of the Polypropylene resin obtained by using catalyst synthesized without using solvent; the image indicate regular shaped polymer particle.

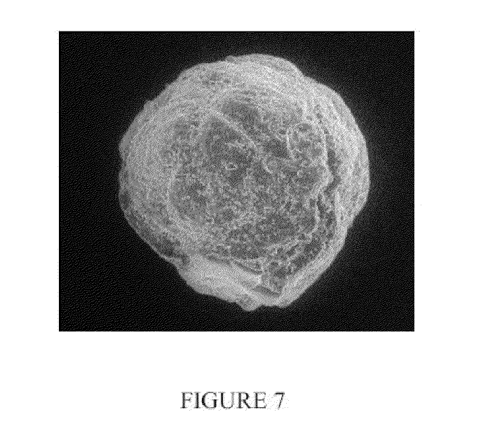

FIG. 8 represents the Scanning Electron Micrograph Study of the Polypropylene resin obtained by using catalyst synthesized with mixture of polar and non-polar solvent; the image indicate regular shaped polymer particle.

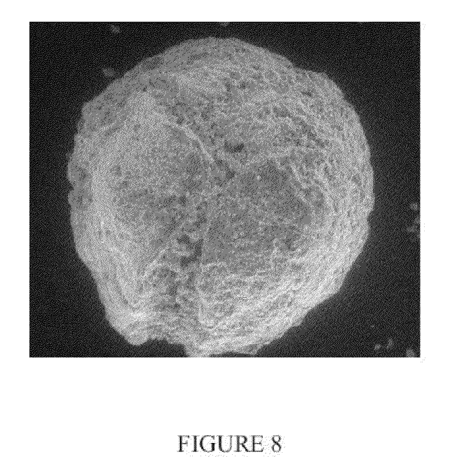

### DETAILED DESCRIPTION

The preparation of polyolefin resins having regular shaped particles and narrow particle size distribution with low polymer-fines is very significant for producing polyolefin resins comprising improved bulk density and better flow-ability. The formation of polyolefin resins comprising regular shaped particles and less polymer-fine largely depends on the morphology of the catalyst being used for the polymerization of olefins. The morphology of the catalyst depends on the morphology of the catalyst pre-cursors being used to synthesize that catalyst.

The term ‘polymer fines’ as used in the context of the specification means a polymer comprising polymer particles of less than 125 μm size.

Accordingly, at least one embodiment of the present invention envisages a process for the preparation of a pro-catalyst component having controlled morphology and less fine contents for a high activity polyolefin catalyst system. At least one embodiment of the present invention further envisages a method for the preparation of polyolefin resin having controlled morphology and less polymer-fine in the presence of high activity polyolefin catalyst system having controlled morphology and less fine contents.

In a first aspect, at least one embodiment of the present invention provides a method for the preparation of a pro-catalyst component comprising titanium, magnesium and halide moieties from spherical shaped magnesium containing precursors, for high activity polyolefin catalyst system having controlled morphology as described herein below: Chemically different types of regular shaped polyolefin pro-catalyst precursors have been reported in the prior-art (Polymer Int, Vol. 58, 40-45, 2009 and Journal of Material Science, Vol. 30, 2809-2820, 1995). As described above, various types of olefin polymerization pro-catalyst precursor comprise magnesium moieties as a major component. Different sources used for magnesium moieties include anhydrous magnesium dichloride, magnesium alkoxides (dialkoxides or aryloxides), or carboxylated magnesium dialkoxides or aryloxides. The use of an adduct of magnesium dichloride and alcohol is also reported in the prior-art.

As disclosed above, the morphology of the catalyst particles works as a template for the synthesis of polymer resins having controlled morphology and reduced polymer-fines. Therefore, in order to obtain polymers of controlled morphology and reduced polymer-fines, the use of regular shaped catalyst particles with very low fine contents is desirable in polymerization chemistry.

At least one embodiment of the present invention envisages a process for the preparation of a polyolefin pro-catalyst component having controlled morphology with low fine contents by using spherical shaped magnesium containing pro-catalyst precursor.

Various methods of preparing the pro-catalyst precursors comprising adduct of magnesium dichloride and alcohol are known in the prior-art including a prolonged reaction of magnesium dichloride with liquid or vaporized alcohol or dissolving magnesium dichloride in electron donor solvents for example alcohols, ethers and re-crystallizing magnesium dichloride from solution. The excess alcohol is then partly removed or spray cooled to get magnesium dichloride/alcohol adducts which is highly spherical or porous. (as disclosed in Korean J. Chem. Eng., Vol. 19(4), 557-563, 2002 and JAPS, Vol 99(3), 945-948, 2006). Similarly, PCT application PCT/IN08/555-2008 describes the preparation of spherical magnesium alkoxides for use in olefin polymerization catalyst.

The use of spherical shaped pro-catalyst precursors to synthesize controlled morphology polyolefin pro-catalyst component is known in the art. The spherical shaped pro-catalyst precursors are fragile in nature. The retention of the spherical morphology of the pro-catalyst precursor during the synthesis of a pro-catalyst component is desirable to produce a pro-catalyst component having controlled morphology and less fine contents. At least one embodiment of the present invention is directed to provide a pro-catalyst component having controlled morphology and minimal fine contents wherein the spherical morphology of the solid pro-catalyst precursor is retained through the reaction.

A suitable method of converting a pro-catalyst precursor into a polyolefin pro-catalyst component comprises a step of charging a magnesium containing pro-catalyst precursor to titanium containing compound in the presence of a specific combination of polar and non-polar solvents at a temperature varying in the range of about 20° C. to about 40° C.

In accordance with at least one embodiment of the present invention, the magnesium containing pro-catalyst precursor is a magnesium dichloride/alcohol adduct. The magnesium dichloride/alcohol adduct as used herein in at least one embodiment of the present invention is spherical in shape and can be synthesized by following any of the conventional methods as described in the prior-art or can be used ready made.

The spherical shaped adduct of magnesium dichloride and alcohol is represented by the formula MgCl₂.nROH, where n is 1 to 8, preferably 2 to 5 and R is C₁-C₁₀ alkyl, preferably C₂ to C₄ alkyl. The magnesium chloride/alcohol adduct is preferably selected from the group consisting of magnesium chloride/methanol, magnesium chloride/ethanol, magnesium chloride/isopropanol, magnesium chloride/propanol, magnesium chloride butanol, magnesium chloride/isobutanol, magnesium chloride/pentanol, magnesium chloride/isopentanol and magnesium chloride/2-ethyl hexanol adduct. Most preferably, the spherical shaped adduct of magnesium dichloride and alcohol is a complex having the formula MgCl₂.nC₂H₅OH.

The preferred titanium compound as used herein in at least one embodiment of the present invention is tetravalent titanium halide; most preferably a titanium tetrachloride.

A first step according to at least one embodiment of the present invention involves the dissolution of titanium tetrachloride in a mixture of solvents comprising a specific combination of polar and non-polar solvents to obtain a slurry. The polar solvent is at least one solvent selected from the group of aromatic halohydrocarbons consisting of chlorobenzene, bromobenzene and trichlorobenzene. The non-polar solvent is at least one selected from the group of aliphatic hydrocarbons consisting of decane, heptane, and nonane.

Preferably the polar and non-polar solvents are mixed in such a ratio that the volume fraction of polar solvent to the total mix is in the range of 1-20% (v/v) and most preferably in the range of 3-7% (v/v).

The slurry comprising titanium tetrachloride mixed with specific combination of polar and non-polar solvent is then heated to a temperature in the range between 20° C. to 40° C.

The magnesium dichloride/alcohol adduct is then suspended in the heated slurry containing titanium tetrachloride mixed with specific combination of polar and non-polar solvent at a temperature of 20° C. to 40° C. to obtain a titanium-magnesium suspension. The molar ratio of magnesium to titanium compound is 0.1 to 1.0. Amount of tetravalent titanium compound is maintained in the range of 30% to 80% w.r.t the mass of the total slurry.

The charging of the magnesium dichloride/alcohol adduct is preferably carried in the form of slurry to avoid contact with moisture. The precursor charging with titanium tetrachloride is carried out at a high temperature varying in the range of 20° C. to 40° C. without affecting the distortion pattern of a resultant catalyst component. The charging of the catalyst precursor at a high temperature is economical, as in contrast with conventional processes as reported in the prior-art, the charging of the precursor with titanium tetrahalide compound carried out at low temperature i.e. around 0° C. has proved to be very costly due to the higher consumption of energy.

A specific combination of polar and non-polar solvents according to at least one embodiment of the present invention, facilitates the high temperature charging of magnesium dichloride/alcohol adduct into titanium tetrachloride and removal of undesired reaction byproducts from the catalyst.

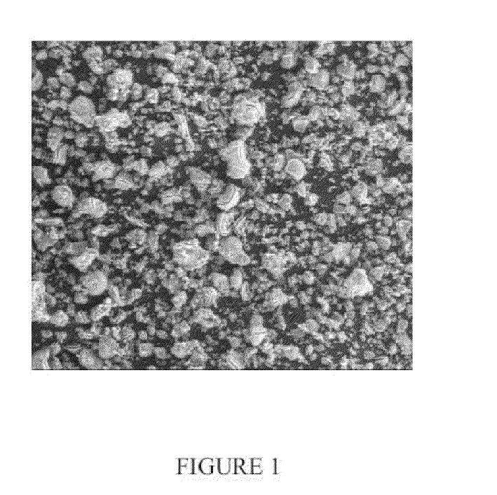

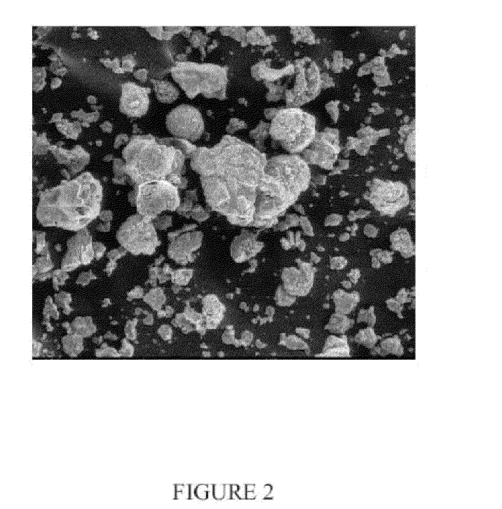

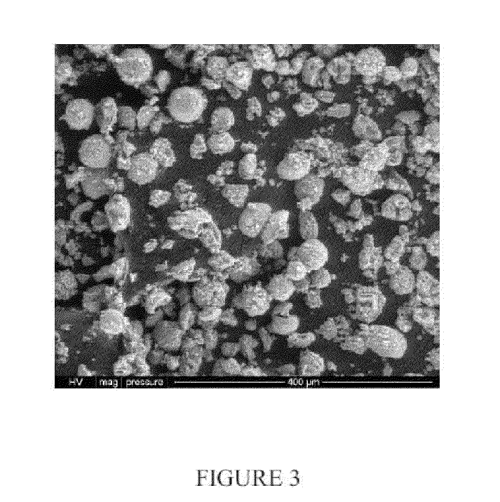

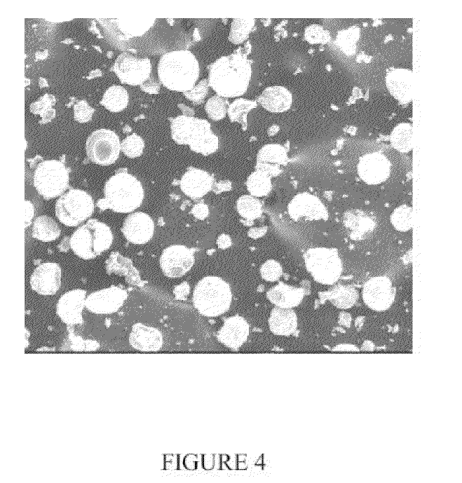

The specific combination of non-polar and polar solvents with titanium tetrachloride helps in controlling certain morphological features of the pro-catalyst formed, during the reaction stage. The use of a non-polar aliphatic solvent with titanium tetrachloride helps in retaining the morphology of the precursor particles during the high temperature charging of the precursor. The Scanning Electron Micrographs (SEM) of pro-catalysts synthesized by using only low polarity solvent at higher and lower charging temperature as presented in FIG. 3 and FIG. 4 respectively, clearly show that the pro-catalyst has controlled morphology and lower fines in comparison to the pro-catalyst synthesized by using high polarity solvent (refer to FIG. 1 and FIG. 2).

The use of a polar solvent with titanium tetrachloride helps in effectively removing the impurities (titanium chloro ethoxy) from the synthesized pro-catalyst (refer to Table 1 ethoxy content).

The process for the preparation of polyolefin pro-catalyst component in accordance with at least one embodiment of the present invention is based on using internal-electron donor compounds.

The next process step of at least one embodiment of the present invention involves the addition of an ester compound as an internal electron donor to the suspension comprising MgCl₂.nC₂H₅OH adduct and TiCl₄ in a specific combination of polar and non-polar solvent to obtain a reaction mixture. The molar ratio of magnesium dichloride/alcohol adduct to diester is from 1.0 to from 10.0.

In accordance with at least one embodiment of the present invention, the amount of internal electron donor is maintained in the range of 0.5 to 5.0% of the mass of the titanium compound.

The manner in which the magnesium dichloride/alcohol adduct and ester compound is added to the titanium containing slurry can be varied.

Preferably, the pro-catalyst precursor, a magnesium dichloride/alcohol adduct is added first to a prepared slurry containing titanium tetrachloride mixed with a specific combination of polar and non-polar solvents. The ester compound is added last after a period lasting from 0 minute to 15 minutes of pre-contact between the precursor and titanium tetrachloride. Preferred contacting times of the precursor with titanium tetrachloride moiety during pro-catalyst synthesis process is 15 minute to 60 minute.

During the addition of an ester compound, the temperature of the suspension comprising magnesium dichloride/alcohol adduct and titanium tetrachloride in a specific combinations of polar and non-polar solvent is maintained in the range of 20° C. to 40° C.

The reaction mixture, thus, obtained containing titanium tetrachloride, magnesium dichloride/alcohol adduct and ester compound mixed in specific combination of polar and non-polar solvent is heated at a temperature of 60° C. to 135° C. for a period of 5 minute to 90 minute to obtain titanium containing pro-catalyst.

The ester compound as used herein in at least one embodiment of the present invention as an internal electron donor compound is selected from the group consisting of ethyl benzoate, methyl benzoate, diisobutyl phthalate, diethyl phthalate, dimethyl phthalate, dioctyl phthalate and diisooctyl phthalate.

The titanium pro-catalyst as obtained in accordance with at least one embodiment of the present invention is separated from the reaction mixture using low attrition methods. The obtained titanium pro-catalyst may contain the excess of unreacted magnesium dichloride/alcohol adduct or other reaction byproducts considered as impurities. The obtained titanium pro-catalyst can be further treated with heated slurry comprising titanium tetrachloride mixed in a specific combination of polar and non-polar solvent.

The treatment of obtained titanium pro-catalyst with heated slurry can be carried out one or more times in order to completely remove the unreacted magnesium dichloride/alcohol adduct and other impurities to obtain pure titanium pro-catalyst.

The treatment of obtained titanium pro-catalyst with heated slurry is carried out in a same manner and at the same reaction conditions of temperature and time, as described earlier.

The ester compound as used herein in at least one embodiment of the present invention is added during the first step of charging of pro-catalyst precursor with titanium tetrachloride in the presence of specific combination of polar and non-polar solvents.

During the final step of the treatment of obtained titanium pro-catalyst with heated slurry comprising titanium tetrachloride mixed with specific combination of polar and non-polar solvent, acid halide compound is added in the reaction mixture. The acid halide compound is added to remove titanium chloride/alkoxy types of impurities. The molar ratio of magnesium dichloride/alcohol adduct to acid halide compound is from 1.0 to 10.0.

After treating the obtained titanium pro-catalyst with heated slurry comprising titanium tetrachloride one or more time, a pure from of titanium pro-catalyst is obtained.

In accordance with one embodiment of the present invention, the preferred acid halide of aromatic monocarboxylic acid is benzoyl chloride.

In accordance with another embodiment of the present invention, the preferred acid halide of aromatic dicarboxylc acid is phthaloyl dichloride.

The production of polymer-fines originates either from the fines in the catalyst or by particle attrition of the growing polymers. The presence of catalyst fines are believed to be the predominant cause of polymer fines. Therefore, in order to obtain the polyolefin pro-catalyst comprising regular shape and very low fine content, it is desirable to retain the morphology of the pro-catalyst precursors through out the pro-catalyst synthesis process.

The process in accordance with at least one embodiment of the present invention involves the step of controlling the agitation time and reaction time to reduce cumulative attritions during various stages of pro-catalyst synthesis in order to reduce the production of large number of pro-catalyst fine particles.

In accordance with at least one embodiment of the present invention, preferably, the agitation time during each stage of pro-catalyst synthesis is limited to a time period varying in the range of 5 minutes to 90 minutes, which is just enough for the completion of the chemical reaction and proper incorporation of active Ti compounds on the solid surface. Most preferably, the agitation time during each stages of pro-catalyst synthesis varies in the range of 15 minutes to 60 minutes.

The speed of the agitator is kept optimum for better heat dissipation and control over the fines. Preferably, the agitator speed is kept in the range of 50 rpm to 500 rpm; most preferable in the range of 100 rpm to 250 rpm.

After completion of the foregoing process, the solid pro-catalyst composition is separated from the reaction medium. The solid pro-catalyst component is separated from the reaction medium by using low attrition methods. The preferred separation methods according to at least one embodiment of the present invention include either decanting, filtration in the reactor it self or use of low attrition pumps for slurry transfer or circulation in filtration equipment. The reaction solvent left after separating the solid pro-catalyst composition is re-used further in subsequent batches.

In accordance with one embodiment of the present invention, the separation of solid pro-catalyst composition from the reaction solvent consists of filtration.

The obtained solid pro-catalyst is then rinsed or washed with a liquid diluent, preferably aliphatic hydrocarbon to remove un-reacted titanium tetrachloride and other free impurities. Typically, the solid pro-catalyst is washed one or more times with an aliphatic hydrocarbon such as n-hexane, cyclohexane, isopentane.

The solid washed pro-catalyst composition is then dried in reactor/filter/drier at a temperature of 20-60° C.

The particles of obtained solid pro-catalyst composition comprise spherical morphology with an average diameter of about 15 microns to 80 microns and particle size distribution span is 0.8 to 1.4

Other than controlling the agitation time and reaction time to reduce the cumulative attritions, the slurry transfer to other vessel using high attrition pumps is also avoided during various stages of pro-catalyst synthesis, as pump causes attrition and subsequent particle breakages.

The titanium pro-catalyst composition of at least one embodiment of the present invention is obtained by employing the specific conditions for high temperature charging of pro-catalyst precursor with titanium tetrachloride in the presence of a specific combination of polar and non-polar solvents and reduced reaction/agitation time comprises particles having regular shape and very low fine content.

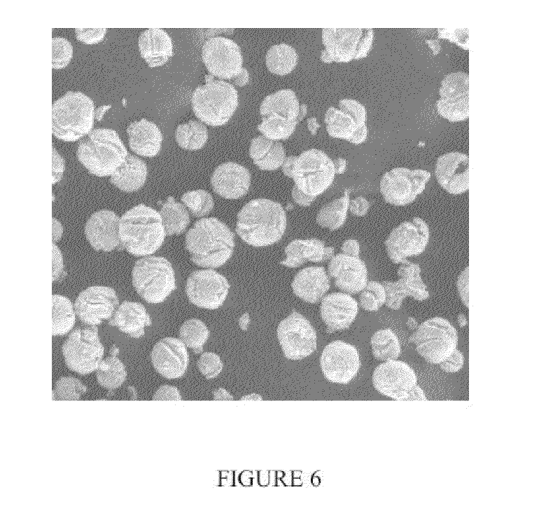

The Scanning Electron Micrograph (SEM) of the titanium pro-catalyst synthesized by using a specific combination of polar and non-polar solvent at higher charging temperature as presented in FIG. 6 of at least one embodiment of the present invention, clearly shows good morphology retention with very low fines.

The comparative analysis of the catalysts synthesized by using different solvents and its mixture at higher and lower temperature is tabulated in Table 1.

TABLE 1
Comparative analysis of catalyst synthesized using high polarity
and low polarity solvent at higher and lower temperature

| | | | | | | Mean | |
|---|---|---|---|---|---|---|---|
| | | Charging | | | | Particle | |
| | | Temp | Ti (wt | Donor | Ethoxy | Size | |
| Example | Solvent | (° C.) | %) | (wt %) | (wt %) | (μm) | Span |
| 1 | Chlorobenzene | 10 | 3.8 ± 0.3 | 7.8 ± 0.5 | 0.2 ± 0.05 | 34 ± 2 | 1.77 |
| 2 | Chlorobenzene | −5 | 4.2 ± 0.3 | 6.5 ± 0.5 | 0.2 ± 0.05 | 36 ± 2 | 1.53 |
| 3 | Decane | 10 | 4.5 ± 0.3 | 10.2 ± 0.5 | 0.4 ± 0.05 | 43 ± 2 | 1.48 |
| 4 | Decane | −5 | 3.6 ± 0.3 | 10.6 ± 0.5 | 0.4 ± 0.05 | 40 ± 2 | 1.36 |
| 5 | No Solvent | 25 | 3.2 ± 0.3 | 12.2 ± 0.5 | 0.9 ± 0.05 | 43 ± 2 | 1.21 |
| 6 | Decane with | 25 | 3.0 ± 0.3 | 11.5 ± 0.5 | 0.3 ± 0.05 | 42 ± 2 | 1.19 |
| | 5% (by | | | | | | |
| | volume) | | | | | | |
| | chlorobenzene | | | | | | |

The Particle size and distribution is comparable in example 5 and 6 but the ethoxy level (indicates impurity) is higher in example 5. From the data as provided in Table-1 of at least one embodiment of the present invention, it clearly understood that the use of mixture of polar and non-polar solvent is effective in morphology retention and also in removal of impurities.

In another aspect of at least one embodiment of the present invention, there is provided a high activity polyolefin catalyst system having controlled morphology comprising:
a) a titanium pro-catalyst component made in accordance with at least one embodiment of the present invention;
b) triethyl aluminum co-catalyst component; and
c) at least one external electron donor.

In still another aspect of at least one embodiment of the present invention, there is provided a process for the polymerization of lower α-olefins in the presence of a high activity polyolefin catalyst having controlled morphology as prepared in accordance with second aspect of at least one embodiment of the present invention to obtain polyolefin having controlled morphology and less polymer-fine.

The process for the preparation of high activity polyolefin catalyst having controlled morphology and its subsequent use for the polymerization of lower α-olefins comprises the following steps:

The first step of the polymerization of lower α-olefins in accordance with at least one embodiment of the present invention comprises an activating step wherein prior to polymerization, the titanium pro-catalyst component having controlled morphology as synthesized in accordance with first aspect of at least one embodiment of the present invention is combined with a co-catalyst component in the presence of at least one inert saturated hydrocarbon to obtain an activated polyolefin catalyst.

The co-catalyst component used in at least one embodiment of the present invention is an organoaluminum compound typically selected from the group consisting of Triethyl aluminium, triisobutyl aluminium, tri n-octyl aluminiumk, diethyl aluminium chloride etc. and most preferably triethyl aluminum.

During an activation step of the titanium pro-catalyst component, an external electron donor is also added in the slurry comprising a titanium pro-catalyst and a co-catalyst component to obtain a high active polyolefin catalyst system. The external electron donor as used herein in at least one embodiment of the present invention may typically be at least one selected from the group consisting of esters of monocarboxylic acids and their substituents, alkoxy alkyl benzoates, alkoxy silanes and dialkoxy silanes. most preferably dicyclohexyl dimethoxy silane.

The next step of the polymerization reaction of at least one embodiment of the present invention comprises of subjecting the monomers of lower α-olefins into the slurry comprising a high activity polyolefin catalyst system composed of a pro-catalyst, a co-catalyst and an at least one external electron donor, in a polymerization reactor under the polymerization condition of pressure of 1 kg/cm² to 40 kg/cm² and of temperature of 20° C. to 80° C. to obtain polyolefins.

Typically, the monomers of lower α-olefins are the monomers of ethylene or propylene; most preferably of propylene.

In accordance with one embodiment of the present invention, the polymerization of propylene is carried out in a polymerization reactor under the polymerization condition of pressure of 1 kg/cm² and of temperature of 20° C. for 10 min. After this step the polymerization pressure is increased to 5 kg/cm² and temperature is increased to 70° C. and polymerization is continued for 120 minutes.

During the activation step, the molar ratio of co-catalyst and titanium pro-catalyst component in terms of the molar ratio of Al/Ti is from 20:1 to 300:1. The molar ratio of cocatalyst and the external electron donor (Al/D) is from 20:1 to 50:1

The polymerization reaction of at least one embodiment of the present invention can be carried out in gas, bulk or slurry phase. The polymerization of the lower α-olefins in accordance with the at least one embodiment of the invention is a slurry phase polymerization carried out in the presence of an at least one inert diluent medium selected from the group consisting of hexane, heptanes, decane, cyclohexane; most preferably hexane.

The Melt Flow Index of the polymer is controlled by regulating the amount of added hydrogen at 50 mmol. At commercial scale, the amount of hydrogen keeps on changing with respect to the required grade.

The melt flow characteristic of the polypropylene, their average particle size and the contents of polymer fine (polymers comprising particles below 125 μm) prepared by using catalysts synthesized in accordance with the method of at least one embodiment of the present invention with out using any solvent and using mixture of polar and non-polar solvent are tabulated in Table 2.

TABLE 2
Comparative analysis of catalyst performance and resin properties

| | | | | Polymer Resin | Resin Particles |
|---|---|---|---|---|---|
| | Activity Kg | XS | MFI | Avg. Particle | below 125 μm |
| Example | PP/g cat | wt % | g/10 min | Size (Inch) | wt % |
| 7 | 8.1 ± 0.4 | 2.5 ± 0.1 | 4.1 ± 0.2 | 0.036 ± 0.002 | 3.6 ± 0.2 |
| 8 | 9.5 ± 0.4 | 2.5 ± 0.1 | 3.8 ± 0.2 | 0.037 ± 0.002 | 1.2 ± 0.2 |

It is evident from the comparative data as provided in Table-2 of at least one embodiment of the present invention that the polyolefin prepared (Example 7) by using a titanium pro-catalyst component synthesized without using any solvent (example-5) contains more polymer-fines in comparison to the polyolefin (example 8) prepared by using a titanium pro-catalyst component synthesized by using a combination of polar and non-polar solvent.

The titanium pro-catalyst component having controlled morphology and less fines produces polyolefin resin comprising the particles of controlled morphology. The use of morphological catalyst system with lower fines also provides better control over polymerization reaction due to improved uniformity and consistent operations in the plant.

The presence of less polymer-fine in the final polyolefin resin product of at least one embodiment of the present invention also improves the hydrogen response and the melt flow index of the polyolefin resin.

The production of polyolefin resin with less polymer-fines, high melt flow index and controlled morphology provides higher throughput of the plant, improved extruder operations, lower feed fluctuations in the extruder. The presence of lower polymer-fines in the polyolefin also results in lower fines carryover to compressor during gas phase polymerization which helps in improving compressor reliability.

At least one embodiment of the invention is further illustrated by way of non-limiting examples:

### Example 1

The magnesium dichloride alcoholate (10 gm) precursor of average size 25-45 μm was added to 25 ml n-decane to make a uniform slurry. The slurry thus prepared was added to a mixture of TiCl₄ and chlorobenzene (230 ml) at 10° C. The prepare slurry was treated a mixture of TiCL₄ and chlorobenzene in three steps at 110° C., internal electron donor Diisobutyl phthalate was added in first step. Upon the completion of first step of the reaction, the solid was separated using decantation and treated again with a mixture of TiCl₄ and chlorobenzene (230 ml) in a same manner. Similarly, the third reaction step was performed. After each step solid liquid separation was done through decantation under nitrogen pressure. Benzoyl Chloride was added in the last step. After three stages treatment, solid procatalyst was given four washes with 200 ml n-hexane each and dried at 50° C. under stream of nitrogen. Solid pro-catalyst of yellow color in 11 gm yield was obtained.

### Example 2

Similar synthesis procedure as described in Example 1, except precursor slurry was charged at (−) 5° C. temperature, instead of 10° C.

### Example 3

Catalyst synthesis procedure of example 1 was followed except in place of chlorobenzene equal volume of decane was used.

### Example 4

Catalyst synthesis procedure of example 2 was followed except in place of chlorobenzene equal volume of decane was used.

### Example 5

Catalyst synthesis procedure of example 1 was followed except in first stage 230 ml of TiCl₄ was used in place of equal volume mixture of 230 ml TiCl₄ and chlorobenzene and precursor slurry was charged at 25° C., instead of 10° C.

### Example 6

Catalyst synthesis procedure of example 1 was followed except in first stage 165 ml of TiCl₄, 8 ml chlorobenzene and 157 ml decane was used in place of equal volume mixture of 230 ml TiCl₄ and chlorobenzene and precursor slurry was charged at 25° C., instead of 10° C.

### Example 7

Solid catalyst (0.07 g) of example 5 was mixed with triethyl aluminum cocatalyst and dicyclohexyl dimethoxy silane as selectivity control agent. The catalyst was mixed in such proportions that the aluminum to titanium ratio was maintained as 250:1. The mole ratio of cocatalyst to external electron donor was kept at 30:1. The catalyst was employed for the polymerization of propylene in slurry phase with hexane as the diluent under 1 kg/cm² propylene pressure for 10 min at 20° C. initially and then pressure was increased to 5 kg/cm² propylene pressure for 120 min at 70° C., 50 mmol of hydrogen is added to control MFI.

### Example 8

Polymerization procedure of example 7 was repeated with catalyst from example 6.

### TECHNICAL ADVANTAGES

Technical advantages of at least one embodiment of the present invention lie in providing a novel method for the preparation of olefin polymerization pro-catalyst composition comprising:
1. the retention of spherical morphology of the pro-catalyst precursors through out the pro-catalyst synthesis process;
2. a novel recipe to handle easily fragileness of pro-catalyst precursors during pro-catalyst synthesis process;
3. easy to operate recipe and process over conventional processes;
4. time and energy saving process over conventional processes;
5. re-use of solvent leads to saving on recovery cost;

“Whenever a range of values is specified, a value up to 10% below and above the lowest and highest numerical value respectively, of the specified range, is included in the scope of at least one embodiment of the invention”.

While considerable emphasis has been placed herein on the preferred embodiments, it will be appreciated that many embodiments can be made and that many changes can be made in the preferred embodiments without departing from the principles of the invention. These and other changes in the preferred embodiments as well as other embodiments of the invention will be apparent to those skilled in the art from the disclosure herein, whereby it is to be distinctly understood that the forgoing descriptive matter to be implemented merely as illustrative of the invention and not as limitation.

1. A process for preparing titanium pro-catalyst for a controlled morphology high activity polyolefin catalyst system, said process comprising the following steps:
(a) preparing a slurry of tetravalent titanium compound in a solvent system, comprising a mixture of polar and non-polar solvents;
(b) heating the slurry to a temperature in the range of 20° C. to 40° C.;
(c) charging spherical magnesium chloride/alcohol adduct to the heated slurry to obtain a titanium magnesium suspension;
(d) adding an ester to the titanium magnesium suspension to obtain a reaction mixture;
(e) agitating the reaction mixture at a temperature in the range of 60° C. to 135° C. for a period of 5 to 60 minutes to obtain a titanium pro-catalyst having spherical morphology;
(f) optionally purifying the titanium pro-catalyst by treating the obtained titanium pro-catalyst with heated slurry comprising tetravalent titanium compound mixed in a specific combination of polar and non-polar solvent at a reaction temperature of 20° C. to 40° C., followed by agitating the reaction mixture at a temperature in the range of 60° C. to 135° C. for a period of 5 to 60 minutes and adding acid halide compound to the treated titanium pro-catalyst.

2. The process as claimed in claim 1, wherein the amount of tetravalent titanium compound is in the range of 30 to 80% of the mass of total slurry; and said tetravalent titanium compound is titanium tetrachloride.

3. The process as claimed in claim 1, wherein the magnesium chloride-alcohol adduct is selected from the group consisting of magnesium chloride-methanol, magnesium chloride-ethanol, magnesium chloride-isopropanol, magnesium chloride-propanol, magnesium chloride-butanol, magnesium chloride-isobutanol, magnesium chloride-pentanol, magnesium chloride-isopentanol and magnesium chloride-2-ethyl hexanol adduct.

4. The process as claimed in claim 1, wherein:
i. the polar solvent is at least one aromatic halohydrocarbon selected from the group consisting of chlorobenzene, bromobenzene and trichlorobenzene; and
ii. the non-polar solvent is at least one aliphatic hydrocarbon selected from the group consisting of heptane, nonane and decane;
wherein, the polar solvent is present in the range of 1-20% (v/v) of the solvent system.

5. The process as claimed in claim 1, wherein ester can be added externally or optionally can be generated in-situ by adding the corresponding acid halide; wherein said ester being selected from the group consisting of ethyl benzoate, methyl benzoate, diisobutyl phthalate, diethyl phthalate, dimethyl phthalate, dioctyl phthalate and diisooctyl phthalate; and said acid halide being selected from the group consisting of benzoyl chloride, phthaloyl chloride and other aliphatic or aromatic acid halides.

6. The process as claimed in claim 1, wherein the amount of ester is in the range of 0.5 to 5.0% of the mass of the titanium compound.

7. The process as claimed in claim 1, wherein the titanium pro-catalyst has a particle size in the range of 15-80 micron and particle size distribution span is 0.8-1.4.

8. A controlled morphology high activity polyolefin catalyst system comprising:
a. titanium pro-catalyst made in accordance with claim 1;
b. triethyl aluminum co-catalyst; and
c. at least one external electron donor.

9. The polyolefin catalyst as claimed in claim 8, wherein the external electron donor is selected from the group consisting of esters of monocarboxylic acids and their substituents, alkoxy alkyl benzoates, alkoxy silanes and dialkoxy silanes.

10. The polyolefin catalyst as claimed in claim 8, wherein the external electron donor is dicyclohexyl dimethoxy silane.

11. A process for the polymerization of α-olefins having from 1 to 10 carbon atoms in the presence of a high activity polyolefin catalyst having controlled morphology as claimed in claim 8, comprising the following steps:
a. an activation step wherein the titanium pro-catalyst having controlled morphology made in accordance with claim 1 is combined with a co-catalyst component to form an activated polyolefin catalyst;
b introducing an external electron donor compound in the activated polyolefin catalyst to form a high activity polyolefin catalyst system;
c. subjecting an α-olefin monomers to the high activity polyolefin catalyst system under the polymerization condition of temperature in the range of 20° C. to 80° C. and of pressure in the range of 1 kg/cm2 to 40 kg/cm2 in a polymerization reactor to obtain polyolefins having controlled morphology and less polymer fines,
wherein, the monomers of α-olefin are the monomers of ethylene or propylene.

12. The process as claimed in claim 11, wherein
i. the co-catalyst and the titanium pro-catalyst component are present in the molar ratio from 20:1 to 300:1; and
ii. the co-catalyst and the external electron donor components are present in the molar ratio from 20:1 to 50:1.

13. The process as claimed in claim 11, wherein the polymerization of lower α-olefins is carried out in any one of the phases selected from the group consisting of slurry phase, gas phase and bulk phase polymerization.

14. The process as claimed in claim 11, wherein the polymerization of lower α-olefins is carried out in an inert diluent medium selected from the group consisting of hexane, heptanes, decane and cyclohexane.

15. The process as claimed in claim 11, wherein
i. the polyolefins have average particle size in the range of 0.035 to 0.15 inch, and
ii. the polymer fines have average particle size below 125 μm are present in the range of 1.0% to 1.4%.
